(19) United States
(12) Patent Application Publication
(10) Pub. No.: US 2009/0213129 A1
(43) Pub. Date: Aug. 27, 2009

(54) Storage Unit and Storage Module for Storing EDID

(76) Inventor: Kuo-Yang Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/036,295

(22) Filed: Feb. 25, 2008

(51) Int. Cl. G06F 12/02

(52) U.S. Cl. 345/544

(57) ABSTRACT

With the aid of a storage unit for storing EDID, a memory unit is merely provided power by a bus power while a related power source is turned off, and power leakage is prevented since possible paths of the power leakage are blocked by reverse biasing of related elements of the storage unit. A storage module including a plurality of the designed storage units have same operations and performance as those of the designed storage unit.

### BACKGROUND OF THE INVENTION

1. Field of the Invention

The present invention relates to a storage unit and a storage module, and more particularly, to a storage unit and a storage module for storing EDID.

2. Description of the Prior Art

Extended display identification data (EDID) is a data structure provided by a computer display to describe its capabilities. It enables a modern personal computer to perceive what kind of monitor is connected to the modern personal computer. EDID is defined by a standard published by the Video Electronics Standards Association (VESA). EDID is utilized for recording information related to a connected monitor, where the recorded information includes a manufacturer name, a product type, a phosphor type, a filter type, timings supported by the monitor, a monitor size, luminance data, and so on. A digital connection named Display Data Channel (DDC) is conventionally utilized for transmitting EDID between a monitor (or a display) and a graphics adapter that allows the monitor to communicate its specifications to the adapter. Standards of DDC are also regulated by VESA. Moreover, DDC and EDID structure can be applied in HDMI communication

A memory unit of an integrated circuit is often utilized in a storage unit for storing EDID and is connected to a video source through DDC, such as the fact that a monitor with EDID connects to a graphic card of a computer through DDC. In HDMI application, EDID shall be read out via DDC if it is only supplied to a bus power. The bus power provides +5V and 50 mA. However, it is not convenient for embedding EDID in a system chip because a power pin may only be connected to a bus power. Energy provided by the bus power is merely sufficient in enabling EDID, which limits the power supplied from this power pin. Therefore, a power switch is added in the present invention to solve this problem.

### SUMMARY OF THE INVENTION

The claimed invention discloses a storage unit for storing extended display identification data (EDID). The storage unit comprises a signal source connector, a first diode, a second diode, a switch, a memory unit, and a display data channel (DDC). The first diode has an input terminal coupled to a power terminal of the signal source connector. The second diode has an output terminal coupled to an output terminal of the first diode, and an input terminal coupled to a first power source. The switch has a first output terminal coupled to the output terminal of the second diode, and an input terminal coupled to a second power source. The memory unit has a first terminal coupled to the first output terminal of the switch for storing EDID information. The display data channel has a first terminal coupled to a signal terminal of the signal source connector, and a second terminal coupled to a second terminal of the memory unit.

The claimed invention further discloses a storage module for storing extended display identification data. The storage module comprises a first storage unit and a second storage unit. The first storage unit comprises a first signal source, a first diode, a second diode, a first memory unit, a first switch, and a first display data channel. The first diode has an input terminal coupled to an output terminal of the first signal source. The second diode has an output terminal coupled to an output terminal of the first diode, and an input terminal coupled to a first power source. The first memory unit has a first terminal coupled to the output terminal of the second diode. The first switch has a first output terminal coupled to the first terminal of the first memory unit, and an input terminal coupled to a second power source. The first display data channel has a first terminal coupled to a signal terminal of the first signal source, and a second terminal coupled to a second terminal of the first memory unit. The second storage unit comprises a second signal source, a third diode, a fourth diode, a second memory unit, a second switch, and a second display data channel. The third diode has an input terminal coupled to an output terminal of the second signal source. The fourth diode has an output terminal coupled to an output terminal of the third diode, and an input terminal coupled to the first power source. The second memory unit has a first terminal coupled to the output terminal of the fourth diode. The second switch has a first output terminal coupled to the first terminal of the second memory unit, and an input terminal coupled to the second power source. The second display data channel has a first terminal coupled to a signal terminal of the second signal source, and a second terminal coupled to a second terminal of the second memory unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a storage unit for storing EDID in the present invention.

FIG. 2 is a diagram for illustrating the integrated circuit applied in the storage unit shown in FIG. 1, where the illustrated integrated circuit and the storage unit shown in FIG. 1 have some elements in common.

FIG. 3 is a diagram of a storage module or storing EDID based on the storage unit shown in FIG. 1.

### DETAILED DESCRIPTION

For neutralizing the defect related to limited power ability of a power pin connected to a bus power, a storage unit and a storage module for storing the EDID are disclosed in the present invention.

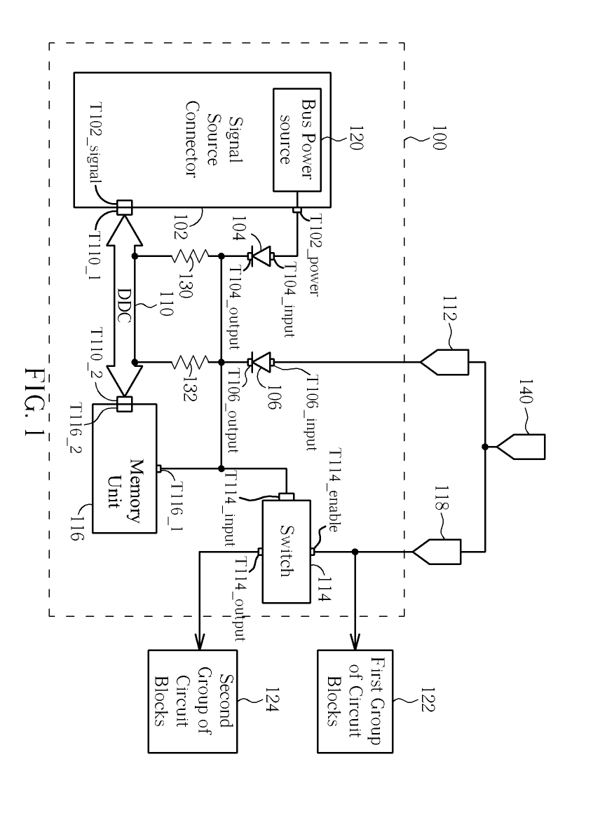

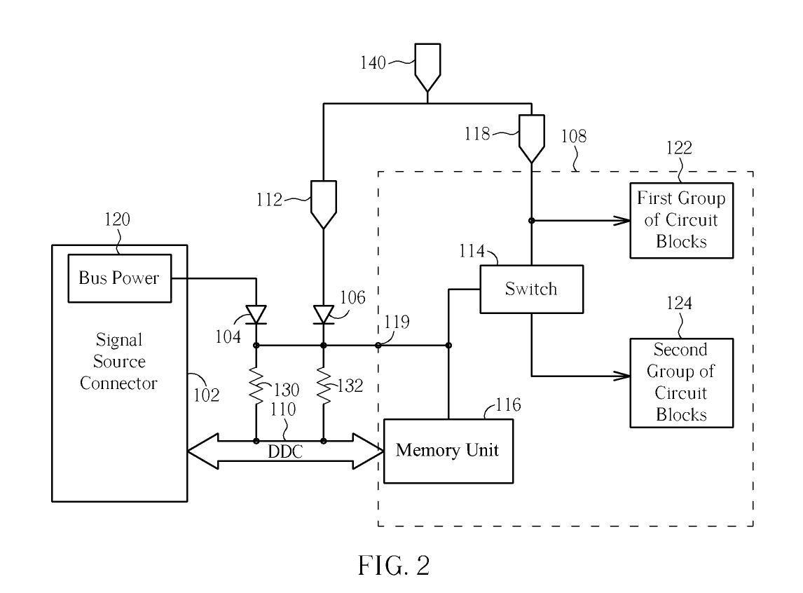

Please refer to FIG. 1, which is a diagram of a storage unit 100 for storing EDID in the present invention. As shown in FIG. 1, the storage unit 100 includes a signal source connector 102, a first diode 104, a second diode 106, a switch 114, a memory unit 116, and a display data channel (DDC) 110. Note that both the switch 114 and the memory unit 116 are disposed within an integrated circuit 108, which is specifically illustrated in FIG. 2 other than in FIG. 1 since the storage unit 100 and the integrated circuit 108 have common elements, i.e., the memory unit 116 and the switch 114. Please refer to FIG. 2, which is a diagram for illustrating the integrated circuit 108 applied in the storage unit 100 shown in FIG. 1, where the illustrated integrated circuit 108 and the storage unit 100 shown in FIG. 1 have some elements in common. The signal source connector 102 may be a video source. The first diode 104 has an input terminal T104_input coupled to a power terminal T102_power of the signal source connector 102. The second diode 106 has an output terminal T106_output coupled to an output terminal T104_output of the first diode 104, and an input terminal T106_input coupled to a first power source 112. The switch 114 has an input terminal T114_input coupled to the output terminal of the second diode 106, and an enable terminal T114_enable coupled to a second power source 118. The memory unit 116 has a first terminal T116_1 coupled to the input terminal T114_input of the switch 114 for storing EDID information. Moreover, the enable terminal T114_enable of the switch 114 is controlled to connect the input terminal T114_input of the switch 114 with the output terminal T114_output of the switch 114. The display data channel 110 has a first terminal T110_1 coupled to a signal terminal T102_signal of the signal source connector 102, and a second terminal T110_2 coupled to a second terminal T116_2 of the memory unit 116. The DDC 110 is responsible for transmitting EDID between the signal terminal T102_signal of the signal source connector 102 and the second terminal T116_2 of the memory unit 116. Both the first power source 112 and the second power source 118 are directly controlled by a same power source 140, which is coupled to both the first power source 112 and the second power source 118 and provides full power of the storage unit 100, which is not illustrated in FIG. 1 for brevity. The signal source connector 102 further includes a bus power source 120 coupled to the power terminal T102_power of the signal source connector 102, where the bus power source 120 is utilized for providing power. A first group of circuit blocks 122 are coupled to the second power source 118, and a second group of circuit blocks 124 are coupled to an output terminal T114_output of the switch 114, where both the first group of circuit blocks 122 and the second group of circuit blocks 124 are disposed on the integrated circuit 108 shown in FIG. 2. Both the first group of circuit blocks 122 and the second group of circuit blocks 124 are parts of the integrated circuit 108. The power source 140 supplies energy to the integrated circuit 108. A first pad 119 gathers energy from either the bus power 120 through the first diode 104 or the first power source 112 through the second diode 106. Furthermore, the first power pad 119 powers up the memory unit 116 and the second group of circuit blocks 124. The second power source 118 supplies energy to the first group of circuit blocks 122. In certain embodiments of the present invention, the storage unit 100 may further includes a first resistor 130 and a second resistor 132 for adjusting power transmitted to the DDC 110. However, except for particularly mentioned, both the first resistor 130 and the second resistor 132 are not included in the following descriptions, and are left as short circuits. Note that the abovementioned terminals of elements are not repeatedly shown in the following diagrams except for necessary conditions for brevity and clearance of said following diagrams.

Operations of the storage unit 100 are classified into a first condition and a second condition and described as follows. The first condition indicates circumstances that merely power from the bus power source 120 is provided to the memory unit 116 when both the first power source 112 and the second power source 118 are turned off. The second condition indicates circumstances that power from both the first power source 112 and the second power source 118 are turned on for supplying power of both the first group of circuit blocks 122 and the second group of circuit blocks 124 and the memory unit 116.

Under the first condition, since merely the bus power source 120 of the signal source connector 102 is required to supply power for the memory unit 116, the power source 140 is turned off so as to turn off both the first power source 112 and the second power source 118. At this time, power from the bus power source 120 is close-to-entirely transmitted to the memory unit 116 since paths related to the power source 140, i.e., paths related to both the first power source 112 and the second power source 118, are blocked by reverse biasing of the second diode 106 and the switch 114, which is also switched off at this time.

Under the second condition, since both the first power source 112 and the second power source 118 are required to supply power for the memory unit 116, the power source 140 is turned on. Therefore, power from the first power source 112 directly powers up the memory unit 116. Turning on the second power source 118 enables the switch 114 and then provides the first power source 112 to the second group of circuit blocks 124 via the switch 114 and the diode 106. The memory unit 116 may merely be supplied with power from the power source 140 with the aid of the first power source 112.

Note that the memory unit 116 may be implemented with a one-time programmable memory or a multiple-time programmable memory. When the memory unit 116 is implemented with a one-time programmable memory, the storage unit 100 may be utilized for storing the static data of the EDID. When the memory unit 116 is implemented with a multiple-time programmable memory, the storage unit 100 may be utilized for storing the dynamic data of the EDID.

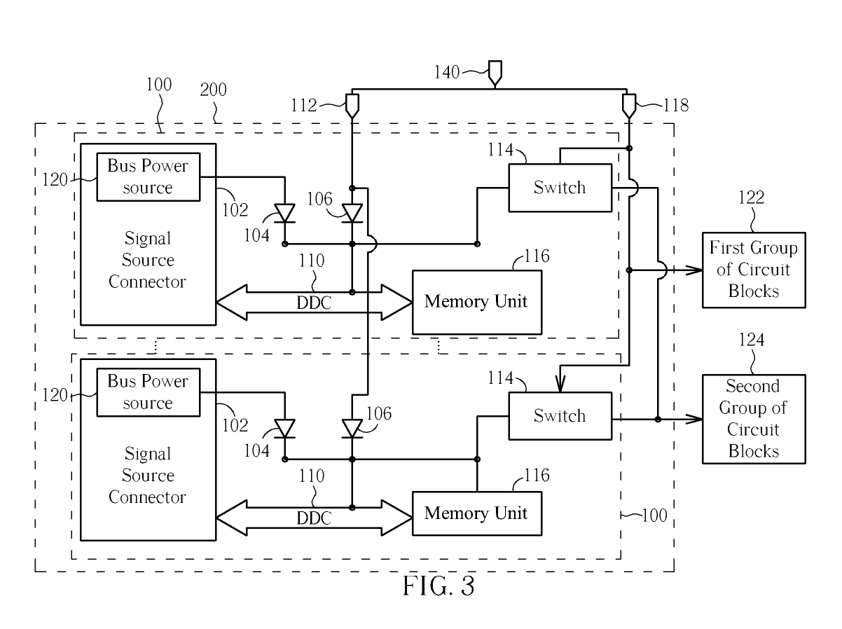

Please refer to FIG. 3, which is a diagram of a storage module 200 for storing EDID based on the storage unit 100 shown in FIG. 1. As shown in FIG. 3, the storage module 200 includes a plurality of storage units 100 shown in FIG. 1, where the plurality of storage units 100 are connected in parallel through both the first power source 112 and the second power source 118. For example, the first power source 112 is coupled to an input terminal T106_input of the second diode 106 of each storage unit 100, and the second power source 118 is connected to an input terminal T114_input of the switch 114 of each storage unit 100 so that all the storage units 100 of the storage module 200 are connected in parallel. Note that the switch 114, the memory unit 116, the first group of circuit blocks 122, and the second group of circuit blocks 124 are disposed within a same integrated circuit, i.e., the integrated circuit 108 shown in FIG. 2. When the storage module 200 is required to store both the static data and the dynamic data of the EDID, at least one memory unit 116 in the storage module 200 may be implemented with a one-time programmable memory for storing the static data, whereas still other at least one memory unit 116 in the storage module 200 may be implemented with a multiple-programmable memory for storing the dynamic data. Note that in a preferred embodiment of the present invention, at least one signal source connector 102 in the storage module 200 may be an analog signal source, and still other at least one signal source connector 102 in the storage module 200 may be a digital signal connector, so that the storage module 200 may be utilized for storing capability of a receiver related to both an analog signal source and a digital signal source simultaneously.

The present invention discloses a storage unit and a storage module, which includes a plurality of the disclosed storage units, for storing the EDID. With the aid of the disclosed storage unit and storage module, when power of the power source is turned off, and is not supplied to the memory unit, and power leakage is prevented since possible paths of the power leakage are blocked by reverse biasing of related elements in the storage unit and the storage module. Moreover, the disclosed storage module may be utilized for storing static data and dynamic data simultaneously with one-time programmable and multiple-time programmable memory units.

Those skilled in the art will readily observe that numerous modifications and alterations of the device and method may be made while retaining the teachings of the invention.

What is claimed is:

1. A storage unit for storing extended display identification data (EDID) comprising:
a signal source connector;
a first diode having an input terminal coupled to a power terminal of the signal source connector;
a second diode having an output terminal coupled to an output terminal of the first diode, and an input terminal coupled to a first power source;
a switch having a first output terminal coupled to the output terminal of the second diode, and an input terminal coupled to a second power source;
a memory unit having a first terminal coupled to the first output terminal of the switch for storing EDID information; and
a display data channel (DDC) having a first terminal coupled to a signal terminal of the signal source connector, and a second terminal coupled to a second terminal of the memory unit.

2. The storage unit of claim 1 wherein when a power source coupled to the first power source and the second power source is turned off, both the first power source and the second power source are shut down, and the switch is switched off.

3. The storage unit of claim 1 wherein when a power source coupled to the first power source and the second power source is turned on, both the first power source and the second power source are turned on, and the switch is switched on so that the first power source is coupled to an output terminal of the switch and a second group of circuit blocks.

4. The storage unit of claim 1 wherein a first group of circuit blocks are coupled to the second power source; wherein a second group of circuit blocks are coupled to an output terminal of the switch; and both the first group of circuit blocks and the second group of circuit blocks are disposed within a same integrated circuit.

5. The storage unit of claim 1 wherein the memory unit is one-time programmable (OTP).

6. The storage unit of claim 1 wherein the memory unit is multiple-time programmable (MTP).

7. The storage unit of claim 1 further comprising:
a first resistor having a first terminal coupled to the output terminal of the first diode, and a second terminal coupled to a first intermediate terminal of the display data channel; and
a second resistor having a first terminal coupled to the output terminal of the second diode, and a second terminal coupled to a second intermediate terminal of the display data channel.

8. The storage unit of claim 1 wherein the input terminal of the first diode is coupled to a bus power source of the signal source connector.

9. The storage unit of claim 1 wherein both the switch and the memory unit are disposed within a same integrated circuit.

10. A storage module for storing extended display identification data (EDID) comprising:
a first storage unit comprising:
a first signal source;
a first diode having an input terminal coupled to an output terminal of the first signal source;
a second diode having an output terminal coupled to an output terminal of the first diode, and an input terminal coupled to a first power source;
a first memory unit having a first terminal coupled to the output terminal of the second diode;
a first switch having an input terminal coupled to the first terminal of the first memory unit, and an enable terminal coupled to a second power source; and
a first display data channel having a first terminal coupled to a signal terminal of the first signal source, and a second terminal coupled to a second terminal of the first memory unit;
a second storage unit comprising:
a second signal source;
a third diode having an input terminal coupled to an output terminal of the second signal source;
a fourth diode having an output terminal coupled to an output terminal of the third diode, and an input terminal coupled to the first power source;
a second memory unit having a first terminal coupled to the output terminal of the fourth diode;
a second switch having an input terminal coupled to the first terminal of the second memory unit, and an enable terminal coupled to the second power source; and
a second display data channel having a first terminal coupled to a signal terminal of the second signal source, and a second terminal coupled to a second terminal of the second memory unit.

11. The storage module of claim 10 wherein when a power source coupled to the first power source and the second power source is turned off, both the first power source and the second power source are shut down, and both the first switch and the second switch are switched off.

12. The storage module of claim 10 wherein a first group of circuit blocks are coupled to the second power source; a second group of circuit blocks are coupled to an output terminal of each one among the first switch and the second switch; and both the first group of circuit blocks and the second group of circuit blocks are disposed within a same integrated circuit.

13. The storage module of claim 12 wherein when a power source coupled to the first power source and the second power source is turned on, both the first power source and the second power source are turned on, the first switch is switched on so that the second power source is coupled to one of the enable terminal of the first memory unit, and the second switch is switched on so that the first power source is coupled to one of the second group of circuit blocks.

14. The storage module of claim 10 wherein both the first memory unit and the second memory unit are one-time programmable.

15. The storage module of claim 10 wherein both the first memory unit and the second memory unit are multiple-time programmable.

16. The storage module of claim 10 wherein the first storage module further comprises:
a first resistor having a first terminal coupled to the output terminal of the first diode, and a second terminal coupled to a first intermediate terminal of the first display data channel; and
a second resistor having a first terminal coupled to the output terminal of the second diode, and a second terminal coupled to a second intermediate terminal of the first display data channel.

17. The storage module of claim 10 wherein the second storage module further comprises:
a third resistor having a first terminal coupled to the output terminal of the third diode, and a second terminal coupled to a first intermediate terminal of the second display data channel; and
a fourth resistor having a first terminal coupled to the output terminal of the fourth diode, and a second terminal coupled to a second intermediate terminal of the second display data channel.

18. The storage module of claim 10 wherein the input terminal of the first diode is coupled to a bus power source of the first signal source, and the input terminal of the third diode is coupled to a bus power source of the second signal source.

19. The storage module of claim 10 wherein the first memory unit, the first switch, the second memory unit, and the second switch are disposed within a same integrated circuit.
